(19) United States
(12) Patent Application Publication
(10) Pub. No.: US 2009/0011180 A1
(43) Pub. Date: Jan. 8, 2009

(54) PRODUCTION METHOD OF PLUGGED HONEYCOMB STRUCTURE

(75) Inventor: Yukihito ICHIKAWA, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/210,808

(22) Filed: Sep. 15, 2008

Related U.S. Application Data
(63) Continuation of application No. PCT/JP2007/055459, filed on Mar. 16, 2007.

(30) Foreign Application Priority Data
Mar. 17, 2006 (JP) 2006-074660
Dec. 18, 2006 (JP) 2006-340163

(51) Int. Cl. B32B 3/12; B29C 47/06

(52) U.S. Cl. 428/117; 264/267

(57) ABSTRACT

There is disclosed a plugged honeycomb structure manufacturing method capable of easily manufacturing a plugged honeycomb structure for use in a filter or the like at low costs so that deposits disposed on an end surface of the structure are reduced, a uniform plugging depth is achieved and especially the plugging depth of a slurry-like plugging material at an outer peripheral portion of the honeycomb structure is easily made uniform. In the method of manufacturing the plugged honeycomb structure in which the plugging portion is formed in one opening end portion of each of predetermined cells of a cylindrical honeycomb structure including a plurality of cells divided by porous partition walls to form channels of a fluid in the form of a honeycomb, a flexible porous member 2 impregnated beforehand with a slurry-like plugging material 1 is pressed onto an end surface 4a of a honeycomb structure 4 to thereby fill cell passages of the honeycomb structure 4 with the slurry-like plugging material 1 contained in the flexible porous member 2 and form plugging portions 4b.

### TECHNICAL FIELD

The present invention relates to a method of manufacturing a plugged honeycomb structure. The present invention more particularly relates to a plugged honeycomb structure manufacturing method capable of easily manufacturing a plugged honeycomb structure at low costs so that deposits deposited on an end surface of the structure are reduced in a case where the structure is used as a filter or the like. The present invention more particularly relates to a method of manufacturing a plugged honeycomb structure in which a plugging depth of a honeycomb structure can easily be made uniform.

### BACKGROUND ART

In recent years, in various fields including cars, chemistry, powers, irons and steels and industrial waste disposal, a plugged honeycomb structure made of a ceramic having excellent resistances to heat and corrosion has been used as a dust collecting filter for use in applications such as environmental countermeasures for prevention of pollution and product recovery from a high-temperature gas. For example, such a plugged honeycomb structure is preferably used as a dust collecting filter for use under a corrosive gas atmosphere at a high temperature, such as a diesel particulate filter (DPF) which traps particulates discharged from a diesel engine (e.g., Patent Document 1).

As shown in FIG. 3, the above-described plugged honeycomb structure for use as the dust collecting filter includes a cylindrical honeycomb structure 23 having porous partition walls 22 which form a plurality of divided cells 24 constituting channels of a fluid; and plugging members 26 which plug one opening of each of predetermined cells and which plug the other opening of each of the remaining cells. In a plugged honeycomb structure 21 shown in FIG. 3, the plugging members 26 alternately plug an inlet side end surface B and an outlet side end surface C of each of the plurality of cells 24.

The above plugged honeycomb structure 21 can be manufactured by obtaining a non-fired cylindrical honeycomb structure having porous partition walls which form a plurality of divided cells forming channels of a fluid by extrusion; then filling, with a plugging slurry including a ceramic, one opening of each of the predetermined cells and the other opening of each of the remaining cells of the resultant non-fired honeycomb structure or a honeycomb structure obtained by firing the non-fired honeycomb structure; and firing the structure.

Furthermore, as a method of manufacturing the plugged honeycomb structure for use as the dust collecting filter described above, there is proposed, for example, a method of attaching an adhesive sheet or the like to one end surface of a formed honeycomb body as a non-fired ceramic dry body; making holes in only portions corresponding to cells (plugged cells) to be plugged in the adhesive sheet or the like by laser processing or the like utilizing image processing to obtain a mask; immersing, into a slurry (a ceramic slurry) the end surface of the formed honeycomb body provided with the mask; filling the plugged cells of the formed honeycomb body with the slurry to form plugging portions; subjecting the other end surface of the formed honeycomb body to steps similar to the above steps; and then drying and firing the body to obtain the plugged honeycomb structure (e.g., Patent Document 1).

[Patent Document 1] JP-A-2001-300922

[Patent Document 2] JP-A-2005-270755

### DISCLOSURE OF THE INVENTION

In the above method of manufacturing the plugged honeycomb structure, in order to make a plugging depth uniform, it is demanded that the cells be plugged uniformly with a slurry-like plugging material including the ceramic slurry. Therefore, a liquid surface of the slurry-like plugging material needs to be leveled in a vessel in which the slurry-like plugging material including the ceramic slurry is stored. However, even during a step of leveling the liquid surface of the slurry-like plugging material, the slurry-like plugging material escapes to side surfaces of the honeycomb structure at an outer peripheral portion of the honeycomb structure. Therefore, there is an unsolved problem that the plugging depth of the slurry-like plugging material at the outer peripheral portion of the honeycomb structure easily decreases. In addition, there is a problem that a honeycomb structure having a larger outer size has more difficulty in leveling the slurry-like plugging material in a vessel to increase fluctuations of plugging depth.

As a result of an intensive investigation, the present inventor has found a step of making the plugging depth uniform, especially a step of easily making uniform the plugging depth of the slurry-like plugging material at the outer peripheral portion of the honeycomb structure to reach the present invention.

To solve the above problem, the present invention provides the following method of manufacturing a plugged honeycomb structure.

[1] A method of manufacturing a plugged honeycomb structure in which a plugging portion is formed in one opening end portion of each of predetermined cells of a cylindrical honeycomb structure including a plurality of cells divided by porous partition walls to form channels of a fluid in the form of a honeycomb, wherein a flexible porous member impregnated beforehand with a slurry-like plugging material is pressed onto an end surface of the honeycomb structure to thereby fill cell passages of the honeycomb structure with the slurry-like plugging material contained in the flexible porous member and form the plugging portions.

[2] A method of manufacturing a plugged honeycomb structure in which a plugging portion is formed in one opening end portion of each of predetermined cells of a cylindrical honeycomb structure including a plurality of cells divided by porous partition walls to form channels of a fluid in the form of a honeycomb, wherein a flexible porous member impregnated beforehand with a slurry-like plugging material is pressed onto an end surface of the honeycomb structure provided with a plugging portion forming mask which covers opening end portions of cells other than plugged cells of the honeycomb structure to thereby fill cell passages of the honeycomb structure with the slurry-like plugging material contained in the flexible porous member and form the plugging portions.

[3] The method of manufacturing a plugged honeycomb structure according to the above [1] or [2], wherein a means for pressing the flexible porous member against the end surface of the honeycomb structure is a roller, and the flexible porous member held by the surface of the roller is impregnated beforehand with the slurry-like plugging material.

[4] The method of manufacturing a plugged honeycomb structure according to the above [1] to [3], wherein the flexible porous member is a fabric-like or a sponge-like porous member or an absorbent member.

[5] A plugged honeycomb structure in which a plugging portion is formed in one opening end portion of each of predetermined cells of a cylindrical honeycomb structure including a plurality of cells divided by porous partition walls to form channels of a fluid in the form of a honeycomb, wherein the plugging portions are formed to have a plurality of layers along the cell passage direction.

[6] A plugged honeycomb structure according to the above [5], wherein the plugging portions are formed to have a plurality of layers along the cell passage direction, and a material for at least one of the layers is different from that of the other layers.

According to the manufacturing method of the present invention, the following effect is produced. That is, in the method of manufacturing the plugged honeycomb structure in which the plugging portion is formed in one opening end portion of each of predetermined cells of the cylindrical honeycomb structure including the plurality of cells divided by the porous partition walls to form the channels of the fluid in the form of the honeycomb, a plugging depth is easily made uniform by a step of holding the slurry-like plugging material by the flexible porous member. A problem to be solved by the present invention is achieved. Furthermore, the plugging depth can freely be adjusted in accordance with a compressive deformation amount of the flexible porous member which holds the slurry-like plugging material. Since the slurry-like plugging material does not escape to side surfaces of the honeycomb structure at an outer peripheral portion of the honeycomb structure, it is possible to solve a problem that the plugging depth at the outer peripheral portion of the honeycomb structure decreases. Furthermore, in a method of plugging the honeycomb structure in a state in which the structure is disposed so as to have a horizontal axis, since the slurry is held in the flexible porous member, the slurry does not sag during the plugging, and fluctuations of the plugging depth can be prevented without damaging an end face of the honeycomb structure.

### BRIEF DESCRIPTION OF THE DRAWINGS

FIG. 1 is a schematic diagram showing one embodiment of the present invention.

FIG. 2 is a schematic diagram showing another embodiment of the present invention.

FIG. 3 is a sectional view showing a constitution of a plugged honeycomb structure.

FIG. 4 is a sectional view showing one example of a honeycomb structure provided with a mask.

FIG. 5 is a schematic diagram showing another embodiment of the present invention.

FIG. 6 is a schematic diagram showing another embodiment of the present invention.

FIG. 7 is a schematic diagram showing another embodiment of the present invention.

FIG. 8 is a schematic diagram showing another embodiment of the present invention.

FIG. 9 is a schematic diagram showing one embodiment of a structure of plugging portions formed in the present invention.

FIG. 10 is a schematic diagram showing another embodiment of a structure of plugging portions formed in the present invention.

### DESCRIPTION OF REFERENCE NUMERALS

1: slurry-like plugging material, 2: flexible porous member, 3: storage vessel, 4: honeycomb structure, 4a: opening end portion of a honeycomb structure, 4b: plugging portion, 5: blade plate, 6: slurry-like plugging material, 7: roller, 8: flexible porous member, 9: honeycomb structure, 9a: upper end surface of honeycomb structure 9, 10: plugging portions, 12: non-fired honeycomb structure, 15a: predetermined cells, 15c: cells (remaining cells) other than predetermined cells, 17a: end face on one side of non-fired honeycomb structure, 19: mask, 20: honeycomb structure provided with mask, 21: plugged honeycomb structure, 22: porous partition wall, 23: honeycomb structure, 24: cell, 26: plugging member, B: end faces in inlet side of a plurality of cells, C: end faces in outlet side of a plurality of cells, 31: slurry-like plugging material, 32: flexible porous member, 33: storage vessel, 34: honeycomb structure, 35: conveyer, 41: slurry-like plugging material, 42: flexible porous member, 43: storage vessel, 44: honeycomb structure, 45: conveyer, 52: flexible porous member, 54: honeycomb structure: 54a: upper end surface of honeycomb structure, 55: conveyer, 64: honeycomb structure, 64a: lower end surface of honeycomb structure, 65: conveyer, 67: roller, 68: gripping mechanism, 70: plugging portion, 71: first layer, 72: second layer, 73: third layer, 74: fourth layer, 75: fifth layer, 76: back face of plugging portion, 77: front face of plugging portion, 78: cell partition wall, 79: end face of honeycomb structure

### BEST MODE FOR CARRYING OUT THE INVENTION

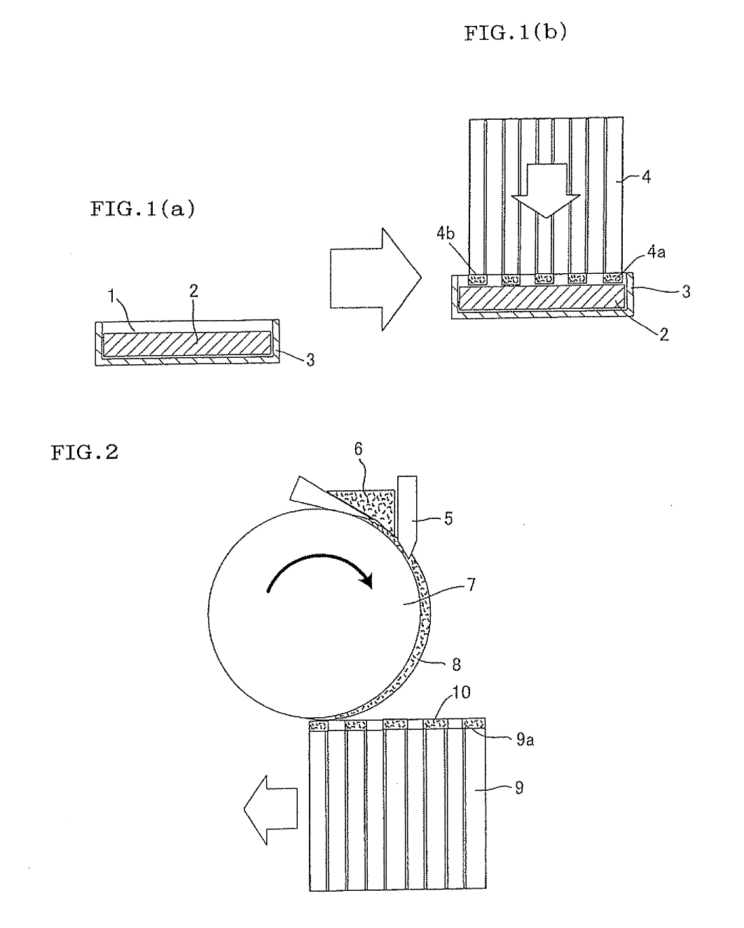

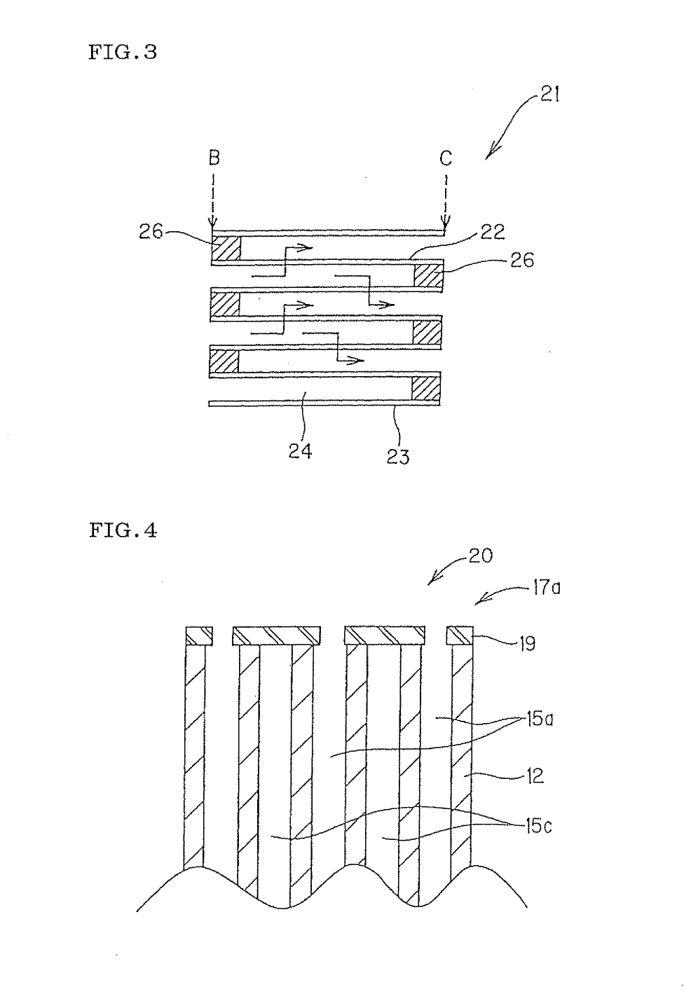

A specific embodiment of the present invention will hereinafter be described with reference to FIGS. 1 and 2. An embodiment of a method of manufacturing a plugged honeycomb structure of the present invention will be described in detail. The present invention is not limited to this embodiment when interpreted, and can variously be changed, modified and improved based on knowledge of a person skilled in the art without departing from the scope of the present invention.

In a cylindrical honeycomb structure, a plurality of cells constituting channels of a fluid are divided by porous partition walls to form a honeycomb shape. The structure is manufactured by a method described in, for example, Patent Document 2. For example, when a forming material including a ceramic is extruded, it is possible to obtain a non-fired cylindrical honeycomb structure having porous partition walls which divide the plurality of cells constituting the channels of the fluid. As the forming material including the ceramic, it is possible to preferably use a material obtained by adding and kneading a binder, a dispersion medium or the like to powder of a ceramic such as cordierite, mullite, alumina, spinel, silicon carbide, silicon nitride, lithium aluminum silicate or aluminum titanate. There is not any special restriction on an extrusion method, but it is possible to use a heretofore known method such as extrusion using a vacuum extruder.

To impregnate the flexible porous member with the slurry-like plugging material, for example, the slurry-like plugging material is uniformly sprayed over the flexible porous member. Alternatively, when the flexible porous member having a compressed state is pressed onto a liquid surface of the slurry-like plugging material, the compressed state of the flexible porous member is released, and the flexible porous member is impregnated with the slurry-like plugging material. The method of impregnating the flexible porous member with the slurry-like plugging material of the present invention is not limited to the above methods when interpreted. The method can variously be changed, modified or improved based on knowledge of any person skilled in the art without departing from the scope of the present invention.

Next, a step of plugging the honeycomb structure with the slurry-like plugging material held by the flexible porous member will be described in more detail.

The flexible porous member is not particularly limited and is preferably a fabric-like or a sponge-like porous member or an absorbent member. The fabric is a fabric obtained by weaving fibers, and examples of the fabric include woven fabric and nonwoven fabric. Examples of the fiber include natural fiber, regenerated fiber such as rayon and cupra, organic polymer fiber such as acetate, Vinylon, elastic and stretchy polyurethane synthetic fabric and polyester fiber whose water absorbability is enhanced by using capillarity, inorganic fiber, and amorphous metal fiber; and the material is not limited. The fibers may be used alone or in combination. In addition, “porous” of a porous member in the present invention means having a function of holding a slurry-like plugging material by using water absorbability, and a porous member includes a member having a large number of protrusions and depressions or a large number of small holes capable of holding the plugging material on the surface of a non-porous member. For example, by forming a large number of small protrusions and depressions or small holes on the surface of the member formed of a rubber material, a function of holding the plugging material on the surface of the rubber member is enhanced. Depending on the amount of the plugging material to be held on the surface of the member, the size of the protrusions and depressions or small holes on the surface of the member can suitably be selected within the range of several micrometers to several millimeters. Further, by forming protrusions and depressions or small holes on the surface of a member of porous material, a function of holding the plugging material on the surface is enhanced. Incidentally, even if the material of the member is a hard material, it can be used because a function of holding the plugging member can be imparted by forming a large number of fine protrusions and depressions or small holes on the surface of the member. However, since a honeycomb structure has low mechanical strength because it is constituted by thin partition walls, partition walls may be damaged at an end face of the honeycomb structure when the member is pressed against the end face. In addition, if the end face of the honeycomb structure has very high flatness over the entire end face, a gap between the surface of the member and the end face has a predetermined distance over the entire end face, and the plugging material is stably supplied into the cells of the entire end face. If the flatness is not secured sufficiently, the gap between the surface of the member and the end face fluctuates, and thereby stable supply of the plugging material into the cells of the entire end face becomes difficult, which increases fluctuations of plugging depth. A honeycomb structure having a larger outer diameter has high possibility of being damaged at an end face and increasing fluctuations of plugging depth. Therefore, it is preferable to impart flexibility to the porous member.

In general, a sponge is a foam having a continuous bubble structure in which unit bubbles each having a perforated partition wall continue to one another. The slurry-like plugging material including a ceramic slurry can be held in the bubble structure. In general, examples of the sponge include polyvinylchloride, polyethylene, vinylon, viscose, nylon, fluororesin, synthetic rubber, phenol resin, urea resin and soft polyurethane, but the present invention is not limited to these materials, and an arbitrary material can be used as the sponge-like member. As the sponge member for use in the present invention, the sponge-like member can be used in a flat vessel fixed as shown in, for example, FIGS. 1(a) and 1(b). However, as shown in FIG. 2, the member can be fixed to the surface of a rotary roller when used. FIGS. 1(a) and 1(b) are diagrams schematically showing one embodiment of the present invention, and FIG. 2 is a diagram schematically showing another embodiment of the present invention. Since a sponge-like member has a continuous air bubble structure and has mutually continuous holes in the partition walls of a unit air bubble, it has excellent water absorbability and can hold a large amount of plugging material, thereby supplying a large amount of plugging material at once into the cells of the honeycomb structure. Therefore, it can suitably be used in the case of forming relatively deep plugging portions.

In the embodiment of the present invention, there is not any special restriction on a type of ceramic powder for the slurry to be used in the slurry-like plugging material. For example, powder similar to or different from the powder of the ceramic included in the forming material to be extruded into the honeycomb structure may be used.

In the embodiment of the present invention, a material obtained by kneading the powder of a ceramic such as cordierite to which the binder, the dispersion medium or the like has been added can preferably be used as the slurry-like plugging material. For example, water, the binder and glycerin may be added to the cordierite powder to prepare the slurry-like plugging material.

Moreover, as the material of the honeycomb structure of the present invention, it is preferable to select, as a main crystal phase, one type from a group consisting of cordierite, silicon carbide, alumina, mullite, aluminum titanate and lithium aluminum silicate (LAS) from viewpoints of strength, heat resistance and the like. It is to be noted that there is an effect that, when the same slurry as that of the honeycomb structure is used as the slurry of the slurry-like plugging material, a coefficient of thermal expansion of the material becomes equal to that of the structure.

Next, a method shown in FIGS. 1(a) and 1(b) will be described in detail. Incidentally, in the following method, the flexible porous member is referred to as a “sponge-like member”.

As shown in FIG. 1(a), to impregnate a sponge-like member 2 with a slurry-like plugging material 1, the sponge-like member 2 is immersed into a storage vessel 3 in which the slurry-like plugging material 1 is stored. Then, as shown in FIG. 1(b), the sponge-like member 2 is disposed in the storage vessel 3 of the slurry-like plugging material 1, and opening end portions 4a of a honeycomb structure 4 are pressed onto the sponge-like member 2 impregnated with the slurry-like plugging material 1. In consequence, plugging portions 4b are formed in the opening end portions 4a of the honeycomb structure 4 to manufacture the honeycomb structure of the present invention.

According to the method of FIGS. 1(a) and 1(b), the plugging depth is adjusted in accordance with an amount (thickness of the sponge-like member) of the slurry-like plugging material 1 to be inserted under pressure, and an objective of the present invention to make the plugging depth uniform is achieved. Since the sponge-like member 2 prevents the slurry-like plugging material 1 from being easily moved in the vessel 3, the slurry-like plugging material 1 cannot escape to side surfaces of the honeycomb structure 4 at an outer peripheral portion of the honeycomb structure 4 during the insertion under pressure.

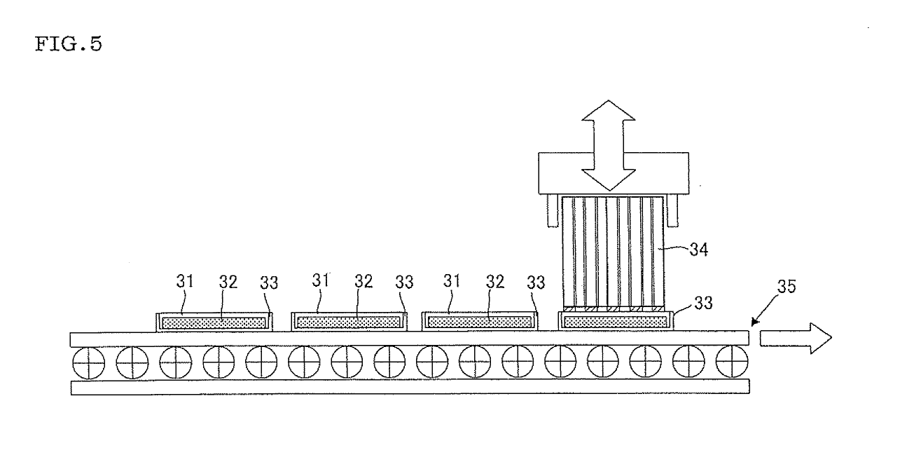

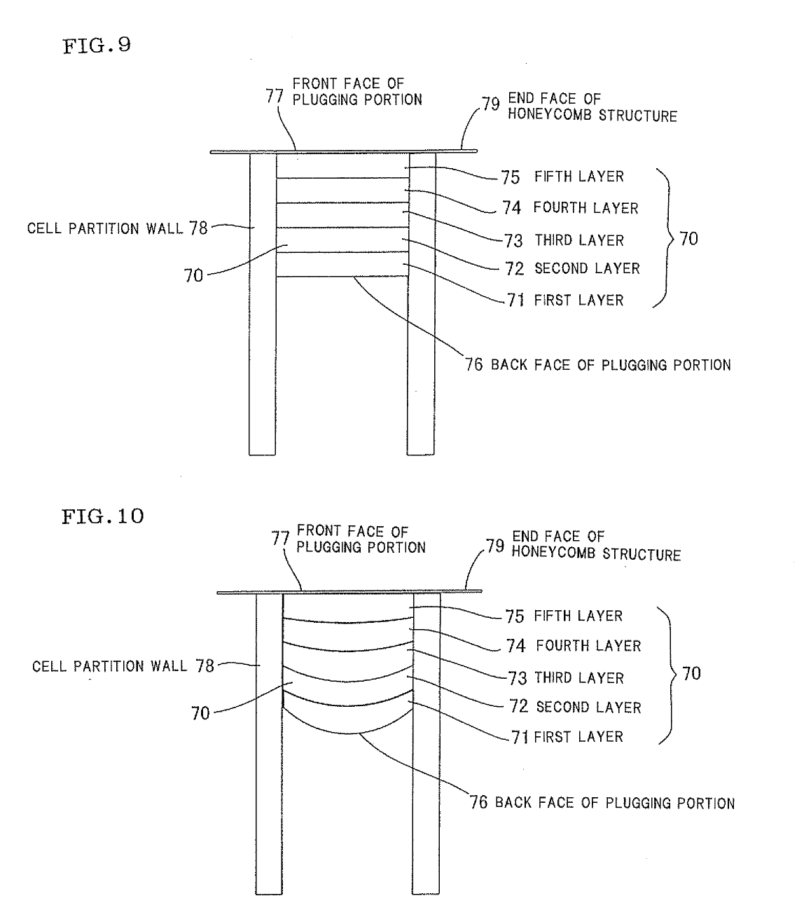

The sponge-like member may be planar or cylindrical. As shown in FIGS. 2 and 7 to 8, speeding up can be realized by a method of plugging with rotating the sponge-like member formed on a roller. Alternatively, there may be employed a method of forming the plugging portions shallowly at one time, which is repeated. By this method, uniformalization of shallow plugging depth becomes easy. Alternatively, there may be employed a method wherein plugging is repeated for one end face of a honeycomb structure with one sponge-like member. Suitable methods include a method where a plurality of planar sponge-like members (porous members) 32 are disposed in series and moved on a conveyer 35 to pass through multistage as shown in FIG. 5 and a method where the sponge-like members are disposed in a rotary-like form and rotated. According to the present invention, as shown in schematic diagrams of FIGS. 9 and 10, there can be obtained a structure of plugging portions formed of a plurality of layers (first layer 71 to fifth layer 75) along the direction of cell passages as plugging portions 70. In addition, by changing characteristics (density, material, etc.) of the plugging members by each layer, plugging portions of different layers can be formed. In DPF, the plugging portions is prone to have higher temperature on the back face side (back side) 76 thereof due to heat generating upon regeneration by combusting diesel particulates. Therefore, it is preferable to form a plugging layer with a material having high heat resistance and high heat capacity on the back face 76 of the plugging portions. In addition, on the exhaust gas inlet side, an erosion phenomenon may be caused due to collision of foreign substances contained in exhaust gas and blown along the exhaust gas flow to collide with the DPF inlet end face. In such a case, it is preferable to form a plugging portion layer of a material having high heat resistance and high hardness on the plugging portion inlet side (front face side) 77. Further, by the present invention, a coat layer having uniform thickness and high hardness over the entire end faces can easily be formed at a high speed on a surface on a partition wall end face side as well as a surface of the plugging portions. When the plugging portions are made dense over the entire depth, rigidity of the plugging portions is increased to raise thermal stress, or concentration of stress may be caused between the plugging portions and the partition walls. Therefore, it is preferable to impart flexibility to the plugging portion by a layered structure of different materials as necessary. Incidentally, in FIGS. 9 and 10, 78 denotes a cell partition wall, and 79 denotes an end face of a honeycomb structure.

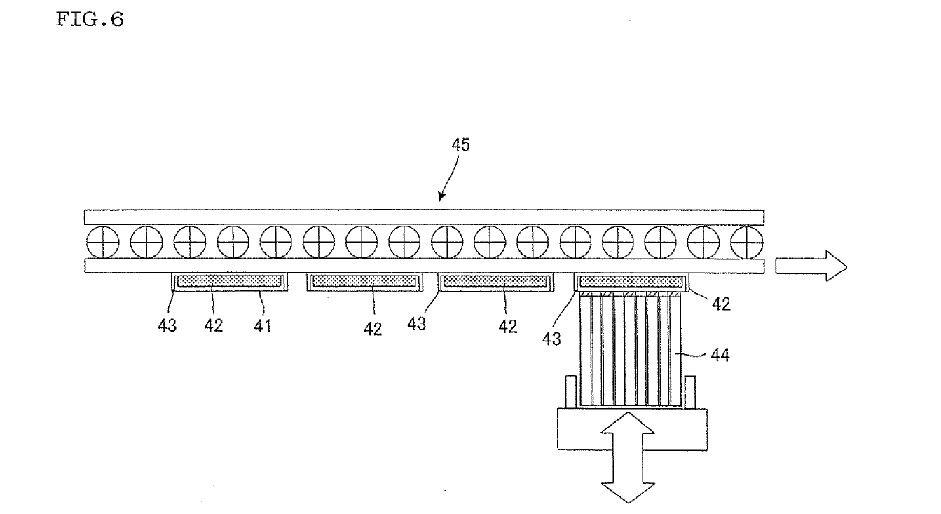

In addition, as shown in FIG. 6, there may be employed a method where a planar sponge-like member (porous member) 42 is disposed on the upper side of a honeycomb structure 44 and subjected to press-fitting. Alternately, the honeycomb structure is disposed in such a manner that the through-holes extends laterally (horizontally), and the sponge-like member (porous member) is disposed on the side so as to correspond with the honeycomb structure. The entire end faces of the honeycomb structure may be plugged with one planar member, or the whole end faces of the honeycomb structure may be divided to be plugged with a plurality of planar members. For example, in the first place, the central portion of the end face of the honeycomb structure is plugged with one planar member, and then the remaining outer peripheral portion of the end face of the honeycomb structure is plugged with another planar member. At this time, the planar member for plugging the outer peripheral portion may be ring-shaped so that a planar portion of an end face of the ring may be pressed against the end face of the honeycomb structure. This makes individual setting up of plugging depth of the central portion and the outer peripheral portion. Similarly, by preferable dividing, plugging depth in an arbitrary position can be set freely.

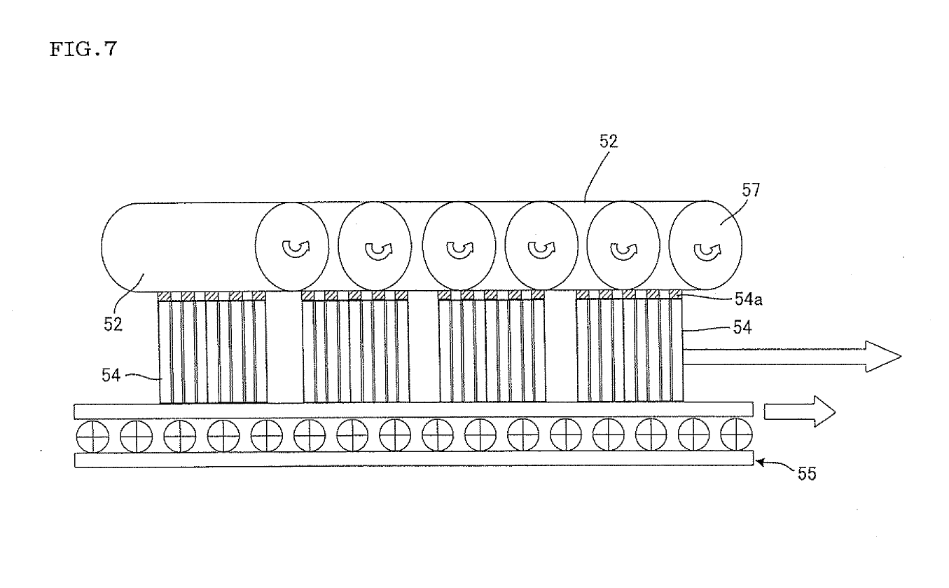

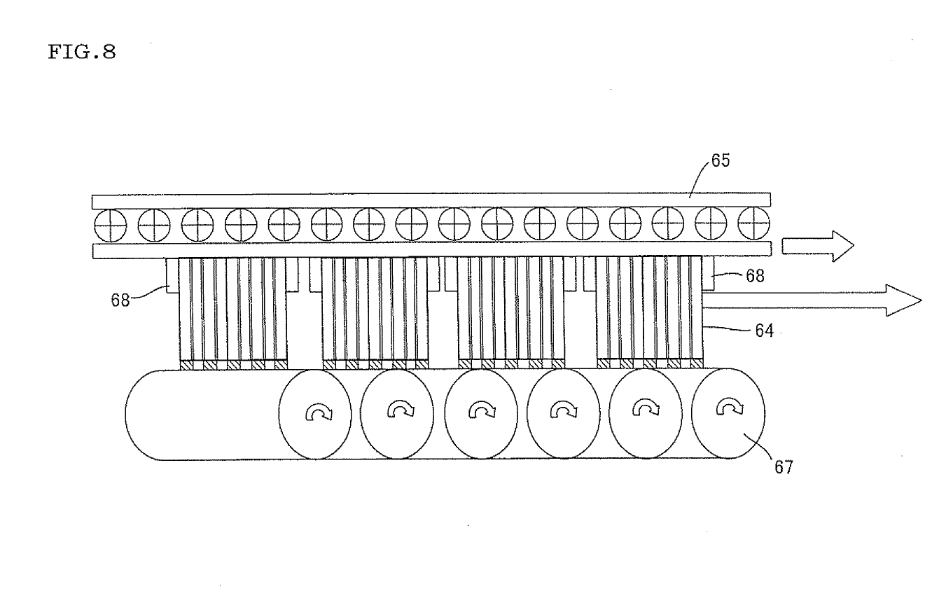

Further, as shown in FIG. 7, a method where a flexible porous member 52 formed on a surface of a roller 57 is pressed against the upper end face 54a of the honeycomb structure 54 with rotating the flexible porous member 52 is preferable because high speed slugging can be achieved. Incidentally, 55 denotes a conveyer, which moves at a predetermined rate with carrying the honeycomb structure 54 thereon. FIG. 8 shows a method where a roller 67 is disposed under the honeycomb structure 64 and pressed against the lower end face 64a of the honeycomb structure 64. Even by this embodiment, the high speed plugging can be achieved as in the embodiment of FIG. 7. In FIG. 8, 65 is a conveyer and moves at a predetermined rate with holding the honeycomb structure 64 by a gripping mechanism 68. Incidentally, there may be employed a method wherein the honeycomb structure is disposed in such a manner that through-holes extend laterally (horizontally) and that the roller is disposed laterally so as to correspond with the honeycomb structure. In addition, a roller having a circular cross section is easily produced. However, the cross section is not limited to a circle and may be an ellipse, an oval, or a polygon such as a triangle. Further, the planar member or a roller-like member is flexible itself to hold the plugging material on the surface thereof. For example, by subjecting a surface of a rubber flat plate or a roller-like member to a sandblast processing treatment or a corrosion treatment, fine protrusions and depressions can be formed on the surface, and a function of holding the plugging material can be imparted to the surface.

When a water content of the slurry-like plugging material of the present invention is increased, viscosity lowers, and the sponge-like member is easily impregnated with the slurry-like plugging material. Therefore, it is especially preferable to increase the content. To prevent the slurry-like plugging material from being leaked from the sponge-like member owing to the decrease of the slurry viscosity, it is preferable that, after the sponge-like member is impregnated with the slurry-like plugging material having a low viscosity, the sponge-like member is dried to thereby evaporate the water content. In consequence, the viscosity of the slurry-like plugging material is appropriately increased.

To make the plugging depth uniform, it is especially preferable that a mask for forming the plugging portions is disposed so as to cover the opening end portions of the cells other than the plugged cells of the honeycomb structure, when the sponge-like member is pressed onto the honeycomb structure. For example, as shown in FIG. 4, one end surface 17a of a non-fired honeycomb structure 12 is provided with a mask 19 which covers openings of cells (remaining cells) 15c other than predetermined cells 15a to obtain a honeycomb structure 20 provided with the mask. Subsequently, as described above, the sponge-like member impregnated with the slurry-like plugging material is pressed to thereby fill cell passages of the honeycomb structure with the slurry-like plugging material contained in the compressed and deformed sponge-like member, thereby forming the plugging portions. There is not any special restriction on a method of supplying the slurry-like plugging material to the sponge. Examples of the method include a method of spraying the plugging material over the surface of the sponge with a spray or the like; a method of feeding the plugging material from the backside of the sponge; and a method of pressing the sponge into a vessel in which the plugging material is stored to allow the sponge to absorb the plugging material.

Here, the mask disposed on one end surface of the non-fired honeycomb structure or the honeycomb structure covers the openings of the cells other than the predetermined cells to thereby introduce the slurry-like plugging material into the only predetermined cells. The mask for use in manufacturing a conventional plugged honeycomb structure can preferably be used. Specifically, examples of the mask include a mask formed by attaching an adhesive sheet to one end surface of the non-fired honeycomb structure or the honeycomb structure, and making holes in predetermined portions corresponding to the predetermined cells by image processing.

There is not any special restriction on a method of drying the slurry-like plugging material, but it is possible to use, for example, a method of drying a honeycomb structure provided with a mask in a state that mounting one end face side of the honeycomb structure on a hot plate or the like, in which one end surface of the structure is provided with an end surface sealing member having a function of drying the plugging material at a high rate to solidify the surfaces of the plugging portions in order to suppress molding sink on the plugged surface; hot air drying performed by spraying hot air to thereby dry the structure; microwave drying; superheat steam drying; far infrared drying; vacuum drying; freeze drying or the like. Furthermore, in a case where an aluminum sheet, a copper sheet or the like is used as the end surface sealing member, the end surface sealing member is energized or inductively heated to generate heat from the end surface sealing member itself. The slurry-like plugging material may be dried by this heat. It is also possible to form a plugging layer by quickly solidifying the plugging material after filling the plugging material into the cells by blending a thermosetting agent such as epoxy resin, phenol resin, melanine resin, and urea resin of a radiosetting agent.

A plugged honeycomb structure precursor obtained by pressing the sponge-like member is fired to obtain the plugged honeycomb structure. There is not any special restriction on a method of firing the plugged honeycomb structure precursor, and the method can be performed according to a firing step of a heretofore known method of manufacturing the plugged honeycomb structure. According to such a method of manufacturing the plugged honeycomb structure, when the structure is used in, for example, a DPF or the like, it is possible to easily manufacture the plugged honeycomb structure at low costs so that deposits deposited on the end surface of the structure are reduced.

Moreover, in the method of manufacturing the plugged honeycomb structure of the present embodiment, when the plugged honeycomb structure precursor is fired using the plugging portion forming mask and the end surface sealing member constituted of a combustible substance, the end surface sealing member may be burnt out. According to such a constitution, the plugging portion forming mask or the end surface sealing member does not have to be removed. Therefore, manufacturing steps can be simplified. Especially, to burn out the end surface sealing member by the firing, it is preferable to use an end surface sealing member constituted of the combustible substance which does not disappear or is not deformed during the drying but which disappears during the firing. Preferable examples of the end surface sealing member include a member made of polyvinylchloride or the like.

Furthermore, in the method of manufacturing the plugged honeycomb structure of the present embodiment, in a case where the plugged honeycomb structure precursor is fired, the mask which covers the openings of the cells other than the predetermined cells may be eliminated. When the end surface sealing member and the mask are simultaneously eliminated during the firing, a step of removing the mask can be omitted, and the manufacturing steps can be simplified.

It is to be noted that in the method of manufacturing the plugged honeycomb structure of the present embodiment, a catalyst may be carried by inner surfaces of the partition walls of the plugged honeycomb structure and/or the inside of the structure obtained by the above method. For example, when the plugged honeycomb structure is used as the DPF, it is preferable to carry a catalyst having a function of promoting combustion of the deposits (particulate substances) trapped by the partition walls. Preferable examples of such a catalyst include a noble metal based catalyst such as Pt, Pd or Rh and a non-metal based perovskite type catalyst. The method of carrying the catalyst can be performed according to a conventional method of carrying the catalyst by a filter such as the DPF.

Next, a method of FIG. 2 will be described in detail. In this method, first, a slurry-like plugging material 6 held by two blade plates 5 is supplied to inner pores of a sponge-like member 8 formed on the surface of a roller 7 by a gravity or by applying a pressure. Next, while the roller 7 provided with the sponge-like member impregnated with the slurry-like plugging material 6 is rotated at a predetermined speed, the roller is pressed onto an upper end surface 9a of a honeycomb structure 9 to thereby continuously supply the slurry-like plugging material 6 contained in the sponge-like member 8 to the honeycomb structure 9. In consequence, plugging portions 10 are formed. According to the method of FIG. 2, since the slurry-like plugging material 6 is held by the sponge-like member 8, the honeycomb structure is vertically disposed beforehand, and the sponge-like member can be pressed onto the upper end surface of the structure to thereby plug the upper end surface of the honeycomb structure. When the honeycomb structure is large and heavy, the light sponge-like member can be moved without vertically moving the honeycomb structure. Therefore, a device can mechanically be simplified, and the honeycomb structure can be prevented from being damaged. Furthermore, the method has a characteristic that the structure can continuously be manufactured as compared with the method of FIG. 1. With regard to a method of supplying slurry to a member 8 of a surface of the roller 7, various methods can be employed without limiting to the method shown in FIG. 2. For example, there may be employed a method where slurry is supplied to the member 8 of the surface of the roller 7 by the use of transcription between rollers via another roller from the slurry storage vessel.

Furthermore, when the honeycomb structure is horizontally disposed and the sponge-like member is pressed onto the opposite end surfaces of the structure at the same time, the slurry-like plugging material contained in the sponge-like member is simultaneously supplied to the opposite end surfaces of the honeycomb structure, and the plugging portions are simultaneously formed in the opposite end surfaces. Therefore, a plugging operation is quickly performed. In such a method, the vessel in which the slurry-like plugging material is stored needs to be vertically disposed. If the sponge is not present, the slurry-like plugging material sags by the gravity, and the plugging depth becomes non-uniform. However, when the sponge-like member is impregnated with the plugging material, the plugging material does not sag, and the plugging depth can easily be made uniform.

### EXAMPLES

A specific implementation result of the method of manufacturing the plugged honeycomb structure of the present invention will hereinafter be described.

### Example 1

For example, as a raw material, a cordierite forming material including talc, kaolin and alumina described above as main materials is blended with water and a binder, dispersed, mixed and kneaded to obtain a forming material. The material is extruded into a columnar shape by a clay kneader, and extruded by an extruder to obtain a formed honeycomb body. When a honeycomb structure is manufactured using the formed body obtained in this manner, the resultant formed body is dried and cut into a predetermined length to obtain a dried body, and cell groups at opposite end surfaces of this dried body are alternately plugged and then fired to obtain a fired body. Next, partition walls of about one to three cells are ground and removed from an outer peripheral wall and an outermost periphery of the resultant fired body. Subsequently, an outer periphery is coated with a ceramic coating material to form the outer peripheral wall. In consequence, the honeycomb structure of cordierite can be obtained. According to such a method, it was possible to manufacture, for example, a honeycomb structure including cells each having a quadrangular section and partition walls each having a thickness of 0.3 mm, and having a reference cell density of 300 cpsi (45.5 cells/cm²). The honeycomb structure had a columnar outer shape (outer diameter: 191 mm, length: 203 mm) after the outer periphery was coated, and had a plugging depth of 10 mm.

A conventional plugging method had a plugging depth precision of 10±5 mm, but a precision of 10±2 mm was obtained by the method of FIGS. 1(a) and 1(b). Similarly, in a honeycomb structure including cells each having a quadrangular section and partition walls each having a thickness of 0.3 mm; having a reference cell density of 200 cpsi (31 cells/cm²); and having a columnar outer shape (an outer diameter: 229 mm, a length: 305 mm) after the outer periphery of the honeycomb structure was coated, and a honeycomb structure having a columnar outer shape (an outer diameter: 460 mm, a length: 500 mm) after the outer periphery was coated, a plugging depth precision equal to the above precision was obtained. These honeycomb structures had characteristics that porosity was 45 to 90%, an average pore diameter was 5 to 50 μm and an average coefficient of thermal expansion in an axial direction at 40 to 800° C. was about 0.1 to 1.0×10⁻⁶/° C.

Moreover, a honeycomb structure having an outer diameter of 191 mm to 460 mm was manufactured using the same materials, in which each cell had a combined sectional shape of octagonal and quadrangular shapes, a partition wall thickness was 0.41 mm and a reference cell density was 300 cpsi (45.5 cells/cm²). Furthermore, it was possible to manufacture a honeycomb structure having a columnar outer shape integrally formed without processing an outer periphery (an outer diameter: 144 mm, a length: 152 mm) and having a plugging depth of 3 mm. A conventional plugging method had a plugging depth precision of 3±2 mm, but a precision of 3±1 mm was obtained by the method of FIGS. 1(a) and 1(b). In consequence, the plugging depth can further be reduced to 1 to 2 mm. At the outer peripheral portion of this honeycomb structure, the cells come into contact with an outer wall to form incomplete cells. Even these incomplete cells were alternately plugged. In a case where the structure is vertically disposed and plugged, the plugging depth precision deteriorates in the conventional method as compared with a case where the structure is horizontally disposed. However, in the present method, the precision does not deteriorate even in the case where the structure is vertically disposed.

### Example 2

As shown in FIG. 5, plugging was performed to a honeycomb structure similar to that of Example 1 in three ways by a method where a plurality of planar flexible porous members 32 are disposed in series and moved on a conveyer 35 to plug in multistage. For convenience, the honeycomb structure is shown by a cross-sectional view. The first plugging could give a plugging depth of about 3 mm by disposing a plurality of porous members (thickness of about 0.5 mm) 32 in series in a vessel 33 containing a slurry-like plugging material 31 and performing plugging 6 times. The IC second plugging could give a plugging depth of about 1.5 mm by disposing a plurality of porous members (thickness of about 0.2 mm) 32 in series in a vessel 33 containing a slurry-like plugging material 31 and performing plugging 6 times. The third plugging could give a plugging depth of about 1 mm by disposing a plurality of porous members (thickness of about 0.15 mm) 32 in series in a vessel 33 containing a slurry-like plugging material 31 and performing plugging 6 times.

### Example 3

By a method where a flexible porous member 52 was formed on a surface of a roller 57 and rotated for plugging as shown in FIG. 7, plugging was performed in three ways to a honeycomb structure similar to that of Example 1. The first plugging could give a plugging depth of about 3 mm by pressing and rotating the roller 57 having a porous member (thickness of about 0.5 mm) 52 impregnated with a slurry-like plugging material and formed on the surface thereof against the upper end face of the honeycomb structure 54 and performing plugging 6 times. The second plugging could give a plugging depth of about 1.5 mm by pressing and rotating the roller 57 having a porous member (thickness of about 0.2 mm) 52 impregnated with a slurry-like plugging material and formed on the surface thereof against the upper end face of the honeycomb structure 54 and performing plugging 6 times. The third plugging could give a plugging depth of about 1 mm by pressing and rotating the roller 57 having a porous member (thickness of about 0.05 mm) 52 impregnated with a slurry-like plugging material and formed on the surface thereof against the upper end face of the honeycomb structure 54 and performing plugging 6 times.

### Example 4

By a method where a flexible porous member 52 was formed on a surface of a roller 57 and rotated for plugging as shown in FIG. 7, the plugging portions has a structure formed of 6 thin layers along a direction of cell passages. For example, in the first plugging, plugging portions having a plugging depth of about 3 mm where 6 layers each having a thickness of about 0.5 mm are piled up. According to the present invention, by varying materials for each layer, there can be obtained a plugging portion structure having different materials along a direction of cell passages. The first layer and the second layer were formed of dense cordierite having a porosity of 10 to 30%, the third and the fourth layers had a porosity of 30 to 45%, and the firth and the sixth layers had a porosity of 45 to 90% to have a structure where the plugging portions had high density and high heat capacity on the back side and high porosity and low rigidity on the front side. The plugging materials of the layers from the first layer to the fourth layer can be densified by adjusting a blending ratio of cordierite raw material and a particle size distribution of each raw material. A suitable amount of foaming resin or water-absorbing polymer was added to the plugging materials for the fifth layer and the sixth layer to raise porosity.

### Example 5

In the same manner as in Example 4, there was obtained a structure of plugging portions having high porosity on the back side and high density on the front side of the plugging portions to have excellent erosion resistance by using high porosity cordierite having a porosity of 45 to 90% for the layers from the first layer to the second layer, a porosity of 30 to 45% for the third and fourth layers, and a porosity of 10 to 30% for the fifth and sixth layers.

It is to be noted that the specific implementation result has been described in accordance with the plugged honeycomb structure (DPF) constituted of the cordierite material, but needless to say, the present invention is applicable to a so-called DPF product made of SiC in which a segment bonding structure of an SiC material is used.

As apparent from the above embodiment, according to the manufacturing method of the present invention, the slurry-like plugging material is held by the sponge-like member. Therefore, even when the sponge-like member is vertically disposed, the slurry-like plugging material does not sag. Even when the honeycomb structure is horizontally disposed and plugged, it is easy to form the plugging portions having a uniform depth.

Furthermore, when the sponge-like member directly comes into contact with an end surface or a mask surface of the honeycomb structure, an effect is produced that an excessive amount of the slurry-like plugging material is not easily left in the end surface or the mask surface of the honeycomb structure as compared with the conventional method. In addition, there may be employed steps of supplying and filling a plugging material into the entire cells of an end face in advance according to the present invention and then removing plugging portions of the cells which should not be plugged.

In addition, the plugging depth can freely be adjusted in accordance with a compressive deformation amount of the sponge-like member. Therefore, when the compressive deformation amount is changed with a portion of the sponge-like member, the plugging depth of the cell disposed in the corresponding position can be changed. For example, when the plugging depth is increased in the center of the honeycomb structure and decreased at the outer peripheral portion of the structure, the slurry-like plugging material does not escape to the honeycomb outer peripheral portion during insertion under pressure, because the sponge-like member prevents the slurry-like plugging material from being easily moved in the vessel.

### INDUSTRIAL APPLICABILITY

A plugged honeycomb structure manufactured by a manufacturing method of the present invention is preferably used in an environmental countermeasure such as prevention of pollution, a dust collecting filter for use in an application such as product recovery from a high-temperature gas, or a dust collecting filter for use under a corrosive gas atmosphere at a high temperature such as a diesel particulate filter (DPF) which traps particulates discharged from a diesel engine, and the structure is remarkably industrially significant.

1-6. (canceled)

7. A method of manufacturing a plugged honeycomb structure in which a plugging portion is formed in one opening end portion of each of predetermined cells of a cylindrical honeycomb structure including a plurality of cells divided by porous partition walls to form channels of a fluid in the form of a honeycomb,
wherein a flexible porous member impregnated beforehand with a slurry-like plugging material is pressed onto an end surface of the honeycomb structure to thereby fill cell passages of the honeycomb structure with the slurry-like plugging material contained in the flexible porous member and form the plugging portions.

8. A method of manufacturing a plugged honeycomb structure in which a plugging portion is formed in one opening end portion of each of predetermined cells of a cylindrical honeycomb structure including a plurality of cells divided by porous partition walls to form channels of a fluid in the form of a honeycomb,
wherein a flexible porous member impregnated beforehand with a slurry-like plugging material is pressed onto an end surface of the honeycomb structure provided with a plugging portion forming mask which covers opening end portions of cells other than plugged cells of the honeycomb structure to thereby fill cell passages of the honeycomb structure with the slurry-like plugging material contained in the flexible porous member and form the plugging portions.

9. The method of manufacturing a plugged honeycomb structure according to claim 7, wherein a means for pressing the flexible porous member against the end surface of the honeycomb structure is a roller, and the flexible porous member held by the surface of the roller is impregnated beforehand with the slurry-like plugging material.

10. The method of manufacturing a plugged honeycomb structure according to claim 8, wherein a means for pressing the flexible porous member against the end surface of the honeycomb structure is a roller, and the flexible porous member held by the surface of the roller is impregnated beforehand with the slurry-like plugging material.

11. The method of manufacturing a plugged honeycomb structure according to claim 7, wherein the flexible porous member is a fabric-like or a sponge-like porous member or an absorbent member.

12. The method of manufacturing a plugged honeycomb structure according to claim 8, wherein the flexible porous member is a fabric-like or a sponge-like porous member or an absorbent member.

13. The method of manufacturing a plugged honeycomb structure according to claim 9, wherein the flexible porous member is a fabric-like or a sponge-like porous member or an absorbent member.

14. The method of manufacturing a plugged honeycomb structure according to claim 10, wherein the flexible porous member is a fabric-like or a sponge-like porous member or an absorbent member.

15. A plugged honeycomb structure in which a plugging portion is formed in one opening end portion of each of predetermined cells of a cylindrical honeycomb structure including a plurality of cells divided by porous partition walls to form channels of a fluid in the form of a honeycomb, wherein the plugging portions are formed to have a plurality of layers along the cell passage direction.

16. A plugged honeycomb structure according to claim 15, wherein the plugging portions are formed to have a plurality of layers along the cell passage direction, and a material for at least one of the layers is different from that of the other layers.
